(19) United States
(12) Patent Application Publication
(10) Pub. No.: US 2010/0041461 A1
(43) Pub. Date: Feb. 18, 2010

(54) GAMBLING GAMES WITH VOLATILITY INDICATION AND SELECTION

(75) Inventors: Randy Demsetz, Algonquin, IL (US); Richard Ditton, Kildeer, IL (US); Laurence Hodgson, Kildeer, IL (US); Leif Marwede, Las Vegas, NV (US)

Correspondence Address: Incredible Technologies, Inc., 3333 North Kennlcott Avenue, Arlington Heights, IL, 60004, US

(73) Assignee: Incredible Technologies, Arlington Heights, IL (US)

(21) Appl. No.: 12/535,806

(22) Filed: Aug. 5, 2009

Related U.S. Application Data
(60) Provisional application No. 61/088,579, filed on Aug. 13, 2008.

(51) Int. Cl. A63F 9/24; A63F 13/00

(52) U.S. Cl. 463/20; 463/30

(57) ABSTRACT

A method for indicating the volatility of a gambling game is disclosed. Specifically, a symbol or symbols are chosen to consistently represent a particular level or subrange of volatilities, and the symbol or symbols are used to specify the volatility or range of volatilities of any given gambling game and to allow the rough comparison of differing levels of volatility between similar gambling devices or different types of gambling games. Gambling games which allow the player themselves to select the volatility of the gambling game as they play are also disclosed.

### OBJECTS OF THE INVENTION

An object of the invention is to provide a method for indicating the volatility of a gambling game.

A second object of the invention is to provide a consistent and simple method of indicating the volatility of a number of different gambling games.

A third object of the invention is to enable players of gambling games to evaluate the volatility of various gambling games without complex mathematical evaluations or other methods which diminish the enjoyment of gambling games.

A fourth object of the invention is to allow players of gambling games to select their preferred volatility level in the play of gambling games and display the selected level in a consistent and simple manner.

Other objects and advantages of the invention will become apparent in the following disclosure.

### SUMMARY OF THE INVENTION

The present invention relates to gambling games which display an indication of their inherent volatility, especially but not limited to comparing the volatilities of other gambling games. Symbols are chosen to consistently represent volatility of any given gambling game, and those symbols are then displayed on individual gambling games to indicate consistently and simply the volatility of that particular gambling game and allow the comparison of the volatility of different gambling games or similar gambling games with differing volatilities that would not otherwise be obvious to the player. Further, gambling games with user-adjustable volatility and accompanying display are made possible incorporating means of selection into gambling games with volatility display.

### BRIEF DESCRIPTION OF THE DRAWINGS

The characteristic features of the invention will be particularly pointed out in the claims. The descriptions of the preferred embodiment refer to the preceding drawings:

FIG. 1 is an abstract representational view of the entire apparatus showing a volatility selection screen.

FIG. 2 shows a flow chart outlining the process by which volatility levels are selected and applied.

FIG. 3 is an abstract representational view of the entire apparatus showing a first volatility indicator.

FIG. 4 is an abstract representational view of the entire apparatus showing a second volatility indicator.

### DESCRIPTION OF THE PREFERRED EMBODIMENT

The description of the preferred embodiment uses the invention in a gaming apparatus of the type usually referred to as a “slot machine.” It could be used in any desired gaming or entertainment device, including but not limited to such things as a video poker game, a video keno game, a combination gaming machine, or even a coin-operated or bartop amusement device. In this description, the term “pull” should be understood to be one event during which the player places a bet of some fixed size and a random outcome determines whether the player loses their bet or receives it or some multiple of it back in the form of a payout. Typically a pull is based upon a bet fixed in some relevant currency, but may also be set in abstract “credits,” which simply represent some fixed unit for placing bets in, and whose value may be fixed or variable in terms of eventual prize payouts in currency. The description assumes that each pull is related to a bet of some number of credits, but any equivalences (currency units instead of credits, “hands” of poker instead of pulls) may be substituted into the invention.

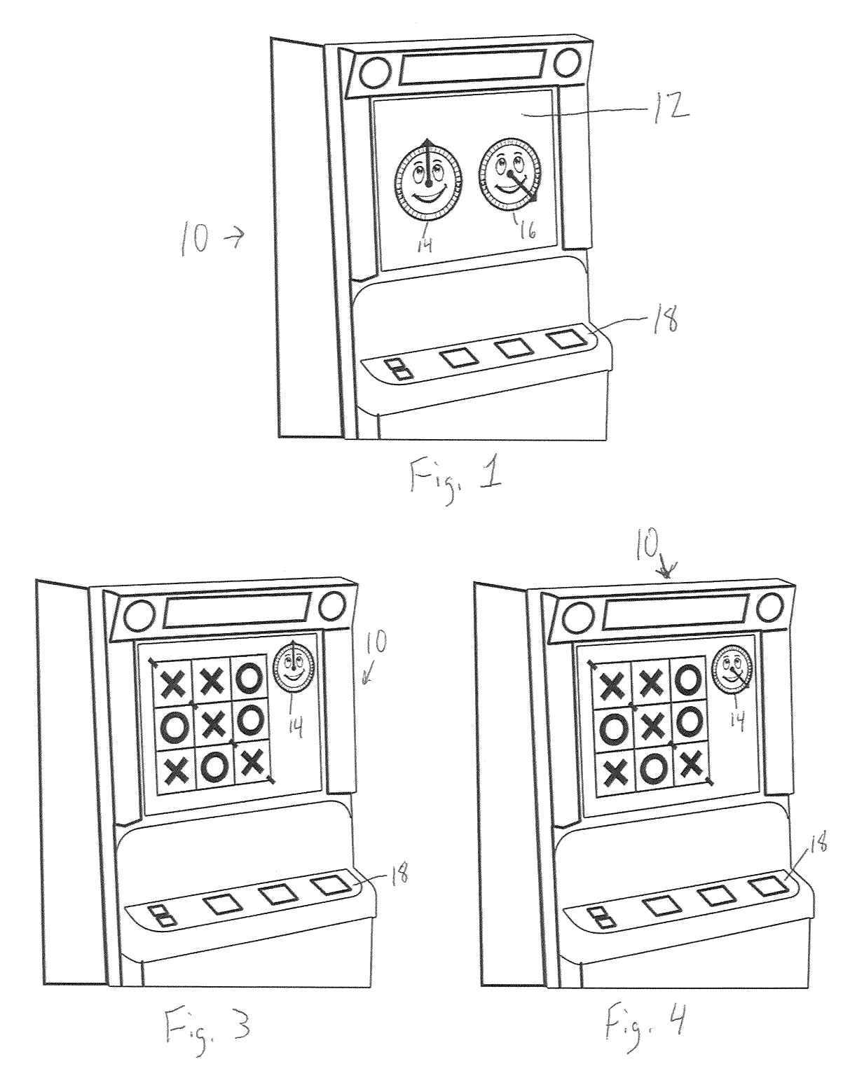

By referring to FIG. 1, the basic concept of the invention may easily be understood. An abstract slot machine 10 is offering the player the choice between a first volatility indicator 14 and a second volatility indicator 16 on touch-screen 12. The player, or whoever sets the preferred level, will simply touch the preferred volatility indicator to set the machine to offer play with the preferred level of volatility. Alternatively, control panel 18 could be used to manually input the player's selection, or any other reasonable method of soliciting and accepting input regarding the volatility could be used. While the volatility indicators shown are pictographic symbols, they could also be simple numbers or letters corresponding to an actual volatility measurement or ranking of some kind.

FIG. 2 shows a flow chart outlining the selection process and its results. As is typical with gaming machines, slot machine 10 should be understood to be set up by the owner/operator to pay out a constant percentage relative to funds input by the end player. Therefore, by selecting either a “high” level of volatility or a “low” level of volatility in volatility selection 206 the user will not affect the actual winnings of the end player over a statistically significant number of pulls. The owner/operator will control certain operations and variables (such as total payout percentage) and the end player will control certain operations and variables (such as the size of the wager placed on any given pull.) When it is important to know who is making decisions and performing actions, they will be identified. When it is not, the person making the decision or performing the action will simply be referred to as the “user.”

In first step 202 the owner/operator initializes the unit (powers it up, performs any desired operations, sets total payout percentage, etc.) This continues until second step 204, wherein the user finishes all desired actions prior to volatility selection 206, where “High” or “Low” volatility is selected. It is required that there be at least two volatility selections, but there may be as many as are desired so long as slot machine 10's controlling mechanisms can accurately calculate outcomes based on the degree of volatility selection offered.

After selecting the desired volatility, the user makes any other decisions and takes any other desired actions prior to slot machine 10 being ready to play. At that point, slot machine 10 goes into “Wait for Pull Event” status 212. It is important to note that volatility selection 206 may be made either by the owner/operator of the slot machine or the end player, whichever the machine is configured to accept such input from, but that preparation 210 may contain elements that are set by the owner/operator and/or the end player. Typically, preparation 210 for the end player might include player identification, game selection, funds or credits input, and initial wager size input. Pull event detection 214 waits for the end player to pull a lever, push a button, touch a control or otherwise initiate a wager determined by a random outcome.

Although two possible paths are shown, it should be understood that all paths are identical with the exception of calculating pull outcomes, and only one path will be described completely. When a pull event detection 214 occurs, slot machine 10 will perform outcome calculation 216, wherein the outcome of the individual pull is determined randomly from a universe of possible outcomes which are calculated taking into account the preset percentage payout and the selected volatility level. It should be noted that this application does not teach a method of populating such a universe, nor does it claim or imply that such creation is obvious or non-novel to a person of ordinary skill in the relevant art. The invention herein is limited to the selection and display of a volatility indicator for a gambling game.

After outcome calculation 216, slot machine 10 displays the outcome, allows any post-pull decision inputs 220 (such as wager changing, new game selection, or requesting a payout of credits remaining) and goes back to waiting for a pull event 212.

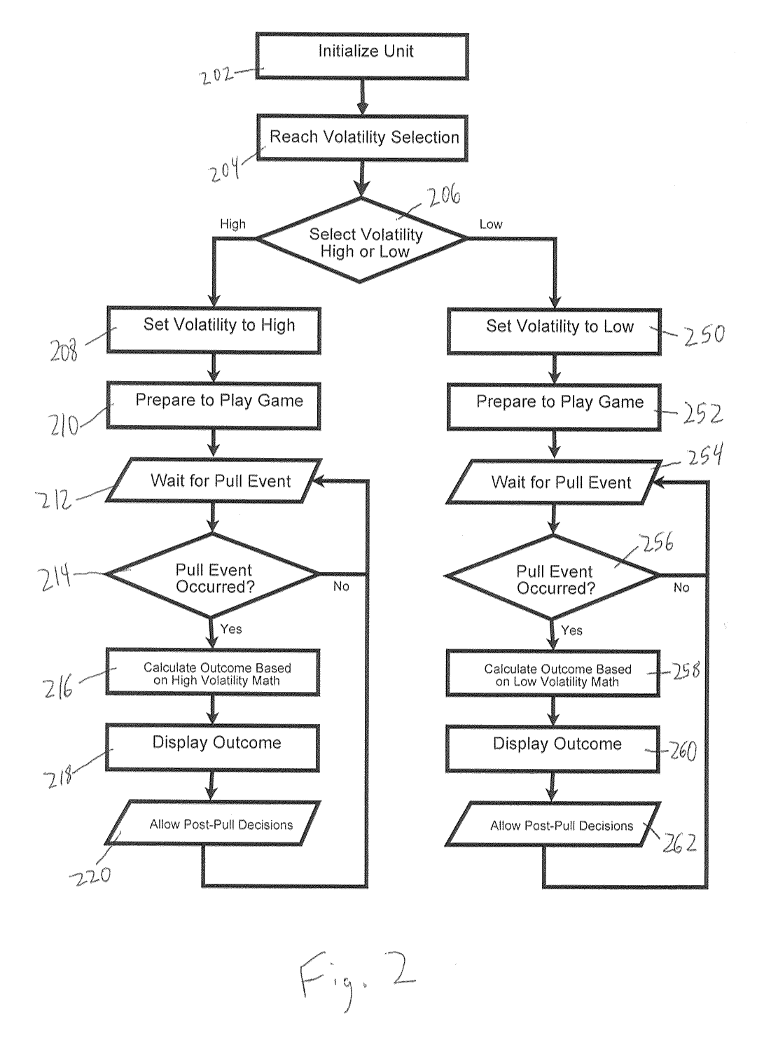

FIG. 3 shows slot machine 10 offering volatility of the first type selectable in FIG. 1. Here, first volatility symbol 14 indicates “high” volatility, which means that prizes will be awarded on more “pulls,” or individual prize-winning possibilities of whatever type, but that those prizes will be relatively smaller, so as to reach the desired percentage of payout over time. Players playing in this mode will go shorter periods of time between winning pulls.

FIG. 4 shows slot machine 10 offering volatility of the second type selectable in FIG. 1. Here second volatility symbol 16 indicates “low” volatility, which means that prizes will be awarded on fewer pulls, but that those prizes will be relatively larger, so as to reach the desired percentage of payout over time. Players playing in this mode will go longer periods of time between winning pulls.

While it is neither required nor preferred to perform extended statistical analysis of the possible outcomes to practice the invention, it is helpful to consider the concept of the “volatility index,” which allows refinement of its practice and improves its use. The volatility index is defined, for purposes of this application, as 1.65 times the Standard Deviation of outcomes, where an outcome is the multiplier of the initial wager which is applied in correspondence with any given random selection from the potential universe of selections. (The number 1.65 is derived from a standard mathematical construction known as a Z-table, which allows the analysis of standard deviation data in relation to the desired confidence in the clustering of outcomes. It corresponds to a 90% confidence.)

Applicant has found through empirical research and experiment that a typical end player might consider a gambling game with a volatility index of 0 to 6 as a “low” volatility game, any game with a volatility index between 6 and 15 as a “medium” volatility game, and any game with a volatility index of more than 15 as a “high” volatility game. The use of these categories, and the accompanying numerical definitions, is neither required nor preferred, but merely forms a convenient initial frame of reference for practitioners of the invention as applied to a specific gambling game. The only required element is that there be at least two discernable volatility levels in any gambling game incorporating the invention and that at some point either the player or the operator be allowed to select between them. This typical response can be used to give additional confidence to the end player in the volatility indicators, even if the actual numbers are not presented to the end player, as well as aid in practicing the volatility selection aspect of the invention.

As an example, if a slot machine has a desired payout percentage of 90% over a statistically significant number of pulls, and a random outcome selector which has twenty possible outcomes, while there are an infinite number of ways to configure the individual possible outcomes to achieve this goal, it is simple, using the invention and the teachings of this application, to evaluate the volatility of a particular group of outcomes and match them to a corresponding volatility indicator.

In a first example, the twenty possible outcomes (each having an equal chance of random selection) might comprise one outcome with a wager multiplier of 18 to 1, and nineteen outcomes with a wage multiplier of zero. Simple statistical analysis would quickly show anyone of ordinary skill in the art that such a configuration would produce an average payout, over time, of 90%, that the standard deviation of the outcomes would be 3.923 (rounded) and the volatility index would be 6.473—a “medium” volatility game. Over a statistically significant number of pulls, he player would only win one in twenty times, but when they did the payout would be quite large relative to the wager. Such a universe of outcomes would correspond in the selection and indication stages to a displayed symbol which indicates medium-volatility play. Alternatively, if the symbols are binary (indicating a selection of a first volatility relatively higher than a selection of a second volatility) such a universe of outcomes would correspond in the selection and indication stages to a displayed symbol which indicates high(er)-volatility play.

In a second example, the twenty possible outcomes (each having an equal chance of random selection) might comprise ten outcomes with a wager multiplier of 1.8 to 1, and ten outcomes with a wage multiplier of zero. Simple statistical analysis would quickly show anyone of ordinary skill in the art that such a configuration would produce an average payout, over time, of 90%—the same as the first example—but that the standard deviation of the outcomes would be 0.9 and the volatility index would be 1.485, producing a “low” volatility game. The player would, over a statistically significant number of pulls, win every other time they played, but when they did the payout would not be very large relative to the wager. Such a universe of outcomes would correspond in the selection and indication stages to a displayed symbol which indicates low(er)-volatility play.

While the description above details the preferred and best mode(s) of practicing the invention, many other configurations and variations are possible. For example:
1) The invention need not be practiced with a commercial gaming unit, but could used with a variety of coin-operated amusement devices, home gaming systems, or any other appropriate system.
2) The invention could be incorporated into games which communicate with each other, update in real time, and adjust volatilities independently, while using the method of indicating volatility to keep players informed about the gambling game's current status.
3) The symbols used could be actual words or numbers describing with any given level of precision the volatility of any given setting.
   Accordingly, the scope of the invention should be determined not by the embodiment(s) illustrated, but by the claims below and their equivalents.

What is claimed is:

1) A method for indicating the volatility of a gambling game, comprising the steps of:
A) Creating a plurality of individual gambling games with a plurality of relative volatility levels playable on a gaming device with a display;
B) Selecting a plurality of volatility symbols and associating each with a relative level of volatility;
C) Communicating to a player the meaning of the plurality of volatility symbols, and;
D) Displaying the volatility symbol associated with the relative level of volatility associated with one of the plurality of individual gambling games on the display while the same one of the plurality of individual gambling games is being played on the gaming device.

2) A method for selecting and then indicating the volatility of a gambling game, comprising the steps of:
A) Creating a plurality of individual gambling games each with a plurality of relative volatility levels associated with a plurality of outcomes, playable on a gaming device with a display;
B) Selecting a plurality of volatility symbols and associating each with a relative level of volatility;
C) Communicating to a user the meaning of the plurality of volatility symbols;
D) Displaying the plurality of volatility symbols on the display so that the user may select one of the plurality of volatility symbols to activate a volatility selection;
E) Displaying the volatility symbol associated with the relative level of volatility associated with one of the plurality of individual gambling games on the display while the same one of the plurality of individual gambling games is being played on the gaming device, and;
F) Controlling the plurality of outcomes of the gambling game being played on the gaming device so that the relative level of volatility of the individual gambling game being played on the gaming device corresponds to the volatility selection and the volatility symbol being displayed on the device during the play of the individual gambling game.

3) A gambling game which indicates its volatility, comprising:
A) A gaming device which can play a plurality of individual gambling games, each individual gambling game having a defined plurality of outcomes;
B) A display, operatively connected to the gaming device, which can display the plurality of individual gambling games and the outcome of an individual gambling game;
C) A plurality of volatility symbols, each volatility symbol indicating a relative level of volatility, and;
D) A volatility display area on the display which shows the volatility symbol associated with the relative level of volatility for the individual gambling game being displayed on the display.

4) A gambling game with selectable and displayable volatility, comprising:
A) A gaming device which can play a plurality of individual gambling games, each individual gambling game having a defined plurality of outcomes;
B) A display, operatively connected to the gaming device, which can display the plurality of individual gambling games and the outcome of an individual gambling game;
C) A plurality of volatility symbols, each volatility symbol indicating a relative level of volatility;
D) A selection area on the display, operably connected to a selection control which displays the plurality of volatility symbols enabling a user to make a volatility selection by selecting a preferred volatility symbol with the selection control prior to playing an individual gambling game, and;
E) A volatility display area on the display which shows the preferred volatility symbol associated with the relative level of volatility for the individual gambling game being displayed on the display.
